(19) United States
(12) Patent Application Publication
(10) Pub. No.: US 2007/0139839 A1
(43) Pub. Date: Jun. 21, 2007

(54) Overcurrent detection circuit and switching circuit

(75) Inventor: Toshio Yoshihara, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 11/634,951

(22) Filed: Dec. 7, 2006

(30) Foreign Application Priority Data
Dec. 16, 2005 (JP) 2005-362607

(51) Int. Cl. H02H 3/08

(52) U.S. Cl. 361/93.1

(57) ABSTRACT

An overcurrent detection circuit of the present invention includes a first transistor having a source connected to a source of an output transistor, a second transistor connected to a current path to a side of a drain of the first transistor, and a detection signal generation circuit connected to a drain of the output transistor and a drain of the first transistor for generating a detection signal corresponding to a difference between a voltage of the first transistor generated by a current of the second transistor and a voltage of the output transistor.

### BACKGROUND OF THE INVENTION

1. Field of the Invention

The present invention relates to an overcurrent detection circuit and a switching circuit, and particularly to an overcurrent detection circuit and a switching circuit for detecting an overcurrent flowing a switching device.

2. Description of Related Art

A class D amplifier that converts an analog input signal into a digital pulse signal to perform amplification by turning on or off a switching device using the pulse signal is known. The class D amplifier can be easily integrated into a circuit. Thus the class D amplifier is widely used for mobile devices such as a cellular phone, a portable player, and a notebook computer.

In the class D amplifier, an output terminal to which a speaker is connected may be short-circuited to a GND potential or a power supply potential due to a failure or a bad connection in the loaded speaker. If the output terminal is short-circuited, an overcurrent will flow in an output transistor that is a switching device and the output transistor could be destroyed. Especially, an on resistance of the output transistor is set to be far smaller than a resistance of the speaker so as to reduce wasteful power loss usually. Thus an unusual amount of current could flow when the speaker was short-circuited. Therefore, in the switching circuit such as the class D amplifier, there is provided a circuit for protecting the output transistor by detecting an overcurrent due to the short circuit of the output transistor.

In Japanese Unexamined Patent Application Publication No. 2002-158542, a drain and a source of an output transistor are input to an operational amplifier to evaluate an output signal from the operational amplifier in order to detect an overcurrent, for example.

In Japanese Unexamined Patent Application Publication No. 2005-136452 as with the Japanese Unexamined Patent Application Publication No. 2002-158542, a detection circuit connected with a drain and a source of an output transistor is disclosed. FIG. 8 illustrates a configuration of a conventional detection circuit similar to the one disclosed in Japanese Unexamined Patent Application Publication No. 2005-136452. In the conventional detection circuit, a source of an output transistor M801 is connected to an input terminal of an operational amplifier OP801 via a diode D801 and a resistance R801. Further, the input terminal is connected to an output terminal of the operational amplifier OP801 via a resistance R802. A drain of the output transistor M801 is connected to another input terminal of the operational amplifier OP801 via a diode D802 and a resistance R803. The another input terminal is connected to a resistance R804. An output signal from the operational amplifier OP801 is evaluated by an evaluation circuit 801.

In the conventional detection circuit of FIG. 8, many components are used therein such as an operational amplifier, a resistance, and a diode. Using the diode generally makes it difficult to integrate into a circuit. Having many components also makes it difficult to downsize the detection circuit. Further, a consumption current increases due to a current flowing the resistance and the operational amplifier. Moreover, it is difficult to increase an accuracy of the detection because there is no way to correct a variation caused in manufacturing the output transistor and temperature characteristic of the output transistor.

As a method to detect an overcurrent, there is another method referring a voltage of a resistance between an output transistor and a power supply, or between an output transistor and a load. FIG. 9 illustrates a configuration of a conventional detection circuit similar to the one disclosed in Japanese Unexamined Patent Application Publication No. 2004-064673. In the conventional detection circuit, a resistance R901 is connected between an output transistor M901 and an output terminal OUT. A detection resistance R901 is connected to an input terminal of an operational amplifier OP901, and another terminal is connected to another input terminal of the operational amplifier OP901 via a power supply source E901. Then an output signal of the operational amplifier OP901 is evaluated by an evaluation circuit 901.

In the conventional circuit of FIG. 9, a current flows from the output transistor to the detection resistance constantly. Thus power is consumed even in a normal operation. To realize high power efficiency, sum of an on resistance of the output transistor and a combined resistance of a detection resistance must be far smaller than a resistance value of a speaker connected to an output terminal OUT. To downsize the circuit, the detection resistance must be far smaller than the combined resistance. For example with a resistance value of a speaker of the portable device is 8Ω and an optimum resistance value of the detection resistance is approximately 0.08Ω. However smaller a value of the detection resistance becomes, a detection voltage becomes also smaller, thus higher detection accuracy is difficult to obtain. Furthermore, it is difficult to integrate resistance devices having a small resistance value with high accuracy.

As described in the foregoing, a conventional detection circuit includes many devices such as a diode and a resistance and so on. Thus it is difficult to downsize a circuit, to integrate into a monolithic circuit, and to lower an amount of consumption current.

### SUMMARY OF THE INVENTION

According to an aspect of the present invention, there is provided an overcurrent detection circuit having a first terminal connected to a power supply and a second terminal connected to a load for detecting an overcurrent flowing a first switching device that includes a first resistance device having a first terminal connected to the first terminal of the first switching device and a second terminal connected to a first constant current source, and a first detection signal generation circuit generating a detection signal corresponding to a difference between a voltage of the second terminal of the first switching device and a voltage of the second terminal of the first resistance device.

According to another aspect of the present invention, there is provided a switching circuit that includes a first switching device having a first terminal connected to a power supply and a second terminal connected to a load, a first resistance device having a first terminal connected to the first terminal of the switching device and a second terminal connected to a first constant current source, a first detection signal generation circuit generating a detection signal corresponding to a difference between a voltage of the second terminal of the first switching device and a voltage of the second terminal of the first resistance device, and an evaluation circuit evaluating a condition of the first switching device according to a control signal supplied to the first switching device and the detect-ion signal.

The present invention provides an overcurrent detection circuit and a switching circuit for facilitating to integrate into a circuit and to downsize, also to reduce consumption current.

### BRIEF DESCRIPTION OF THE DRAWING

The above and other objects, advantages and features of the present invention will be more apparent from the following description taken in conjunction with the accompanying drawings, in which:

FIG. 1 is a block diagram illustrating a configuration of a class D amplifier according to the present invention;

FIGS. 2A to 2I are waveform diagrams illustrating each signals of the class D amplifier according to the present invention;

FIG. 3 is a block diagram illustrating a configuration of a switching circuit according to the present invention;

FIG. 4 is a circuit diagram illustrating a configuration of a high side voltage detection circuit according to the present invention;

FIG. 5 is a circuit diagram illustrating a configuration of a low side voltage detection circuit according to the present invention;

FIGS. 6A and 6B are timing charts illustrating operations of the switching circuit according to the present invention;

FIG. 7 is a circuit diagram illustrating a configuration of the high side voltage detection circuit according to the present invention;

FIG. 8 is a circuit diagram illustrating a voltage detection circuit according to a conventional technique; and

FIG. 9 is a circuit diagram illustrating a voltage detection circuit according to a conventional technique.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposes.

### First Embodiment

An overcurrent detection circuit and a class D amplifier of a first embodiment of the present invention are described hereinafter in detail. The overcurrent detection circuit of this embodiment accurately generates a reference voltage for detecting an overcurrent. Further, smaller numbers of transistors are used to compare the reference voltage and a voltage of the output transistor.

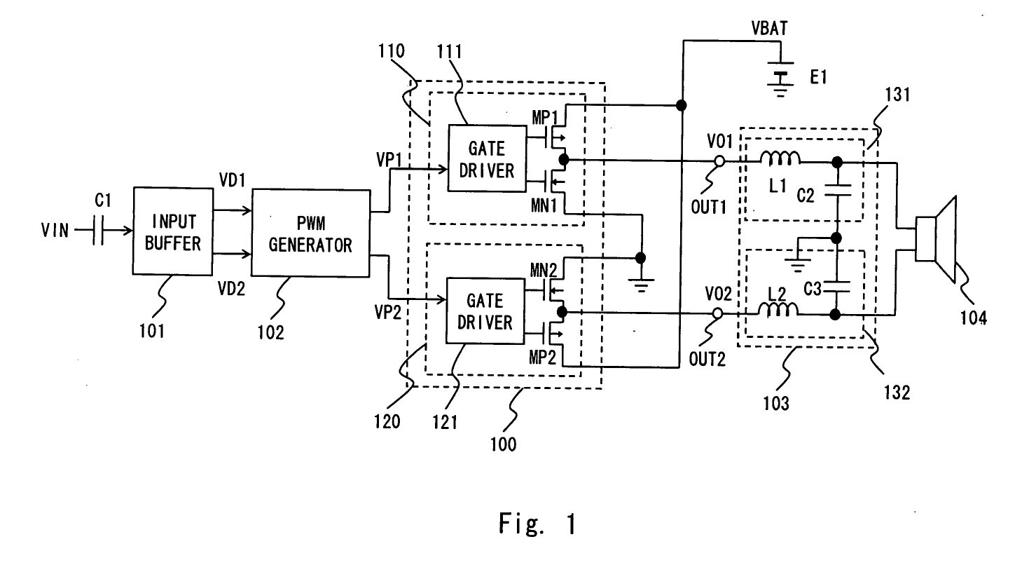

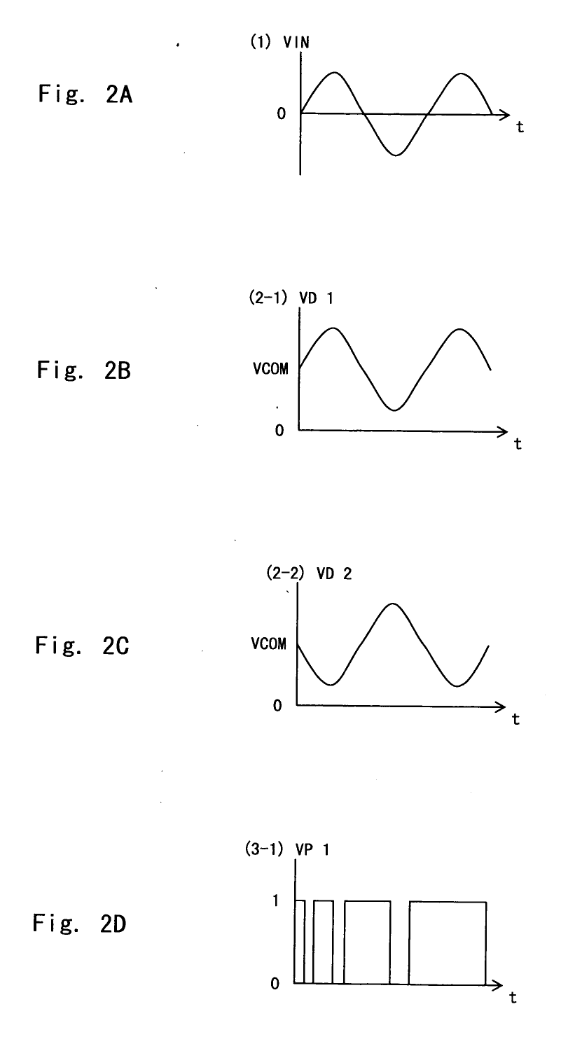

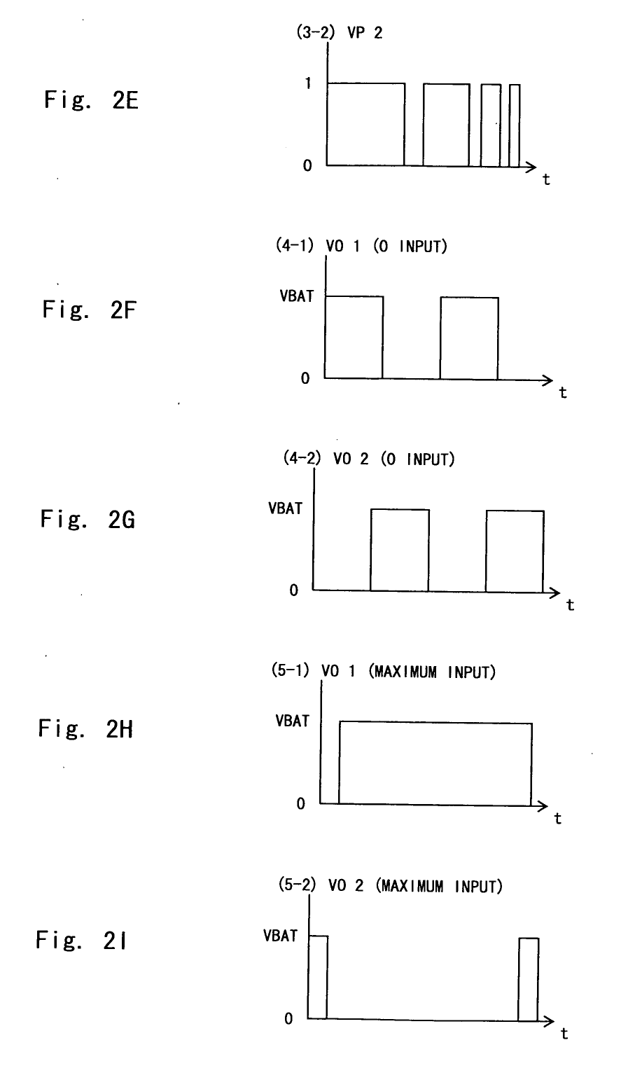

FIG. 1 illustrates a configuration of the class D amplifier of this embodiment. FIGS. 2A to 2I illustrate waveforms of each signals used in the class D amplifier. As shown in FIG. 1, the class D amplifier includes a capacitor Cl, an input buffer 101, a PWM generator 102, a driving circuit (switching circuit) 100, a power supply E1, a lowpass filter 103, and a speaker 104. These circuits are mounted to a semiconductor apparatus. For example components from the input buffer 101 to the output terminals OUT1 and OUT2 can be mounted to a monolithic semiconductor chip.

The input buffer 101 converts an analog input signal input via the capacitor C1 into an analog differential signal. For example, if input voltage VIN as shown in FIG. 2A is input, the input buffer 101 outputs a differential voltage VD1 as shown in FIG. 2B and a differential voltage VD2 as shown in FIG. 2C.

A Direct-current component of the input voltage VIN is removed and the input voltage VIN swings centering on 0V. The differential voltages VD1 and VD2 are signals whose phases inverted to each other, swinging centering on a common voltage VCOM.

A PWM generator 102 modulates each of an analog differential signal that is generated by the input buffer 101 by using the PWM (Pulse Width Modulation) and converts it into a digital PWM logical signal. The PWM logical signal is a digital signal that is obtained by converting a level of an analog signal into a pulse width. For example if the differential voltages VD1 and VD2 being input, the PWM generator 102 outputs a PWM logical signal VP1 as shown in FIG. 2D and a PWM logical signal VP2 as shown in FIG. 2E. The PWM logical signals VP1 and VP2 are differential signals whose phases are inverted to each other corresponding to the differential voltages VD1 and VD2.

The driving circuit 100 outputs a power supply voltage VBAT in response to a PWM logical signal generated by the PWM generator 102 to output a PWM wave. The driving circuit 100 is an output circuit that corresponds to an output stage of the class D amplifier. The driving circuit 100 may be a half-bridge type or a full-bridge type that is made by combining two half-bridge types. However in this example, the driving circuit 100 is a full-bridge type. The driving circuit 100 includes switching circuits 110 and 120. In case that the driving circuit 100 is a half-bridge type, it is possible to operate with just one switching circuit.

The switching circuit 110 controls a current flowing the speaker 104, which is a load, in response to the PWM logical signal VP1. The switching circuit 110 includes a gate driver 111, output transistors (switching devices) MP1 and MN1. The switching circuit 100 includes an overcurrent detection circuit (not shown) which is described later in detail. The switching circuit 100 is a push-pull amplifier circuit. That is, the output transistors MP1 and MN1 are controlled to operate complementary to each other by the gate driver 111.

The gate driver 111 generates gate voltages (control signals) of the output transistors MP1 and MN1 in response to the PWM logical signal VP1. The output transistor MP1 is a high side switch disposed closer to a side of a power supply than an output terminal. The output transistor MP1 is a P channel type power MOS transistor. The output transistor MN1 is a low side switch disposed closer to a side of a GND potential than the output terminal. The output transistor MN1 is an N channel type power MOS transistor. The output transistors MP1 and MN1 are connected in series.

The power supply voltage VBAT is supplied to a source (a first terminal) of the output transistor MP1 from a power supply El. A gate of the output transistor MP1 is connected to the gate driver 111. A drain (a second terminal) of the output transistor MP1 is connected to a drain of the output transistor MN1. An intermediate node between the output transistor MP1 and MN1 is connected to an output terminal OUT1 that outputs an output signal. The output transistor MN1 has a gate connected to the gate driver 111 and a source connected to ground. Incidentally, the output transistors MP1 and MN1 could be a MOS transistor of same conductivity type as long as the output transistors MP1 and MN1 operate complementary.

The switching circuit 120 controls a current flowing a load in response to the PWM logical signal VP2. The switching circuit 120 includes a gate driver 121, output transistors (switching devices) MN2 and MP2. Further, the switching circuit 120 includes the overcurrent detection circuit (not shown) which is described later in detail.

Components in the switching circuit 120 are identical to those in the switching circuit 110. The power supply voltage VBAT is supplied to a source of the output transistor MP2 from the power supply E1. A gate of the output transistor MP2 is connected to the gate driver 121. A drain of the output transistor MP2 is connected to a drain of the output transistors MN1. An intermediate node between the output transistor MP2 and MN2 is connected to an output terminal OUT2 that outputs an output signal. The N channel type output transistor MN2 has a gate connected to the gate driver 121 and a source connected to ground.

The output signal from the switching circuit 110 and the output signal from the switching circuit 120 are signals whose phases are inverted to each other. For example with an input signal being 0 (no input), an output signal VO1 as shown in FIG. 2F is output from the switching circuit 110, and an output signal VO2 as shown in FIG. 2G is output from the switching circuit 120. In this case, a duty ratio of the output signals VO1 and VO2 is 50%. An average of the output power will be a minimum.

With an input signal being the maximum input, the output signal VO1 as shown in FIG. 2H is output from the switching circuit 110, and the output signal VO2 as shown in FIG. 2I is output from the switching circuit 120. In this case, the duty ratio of the output signal VO1 increases and the duty ratio of the output signal VO2 decreases. An average of the output power will be a maximum.

The lowpass filter 103 removes high-frequency component in the PWM wave output from the driving circuit 100 and supplies the PWM wave to the speaker 104, which is a load. The lowpass filter 103 includes LC filters 131 and 132 corresponding to the output signal from the driving circuit 100.

The LC filter 131 removes high-frequency component in the output signal from the switching circuit 110. The LC filter 131 includes a coil L1 and a capacitor C2. The coil L1 is connected to the output terminal OUT1 and a terminal of the speaker 104. The capacitor C2 is connected between an intermediate node, which is between the coil L1 and the speaker 104, and a GND potential.

The LC filter 132 removes high-frequency component in the output signal from the switching circuit 120. The LC filter 132 includes a coil L2 and a capacitor C3. The coil L2 is connected between an output terminal OUT2 and another terminal of the speaker 104. The capacitor C3 is connected between an intermediate node, which is between the coil L2 and the speaker 104, and the GND potential.

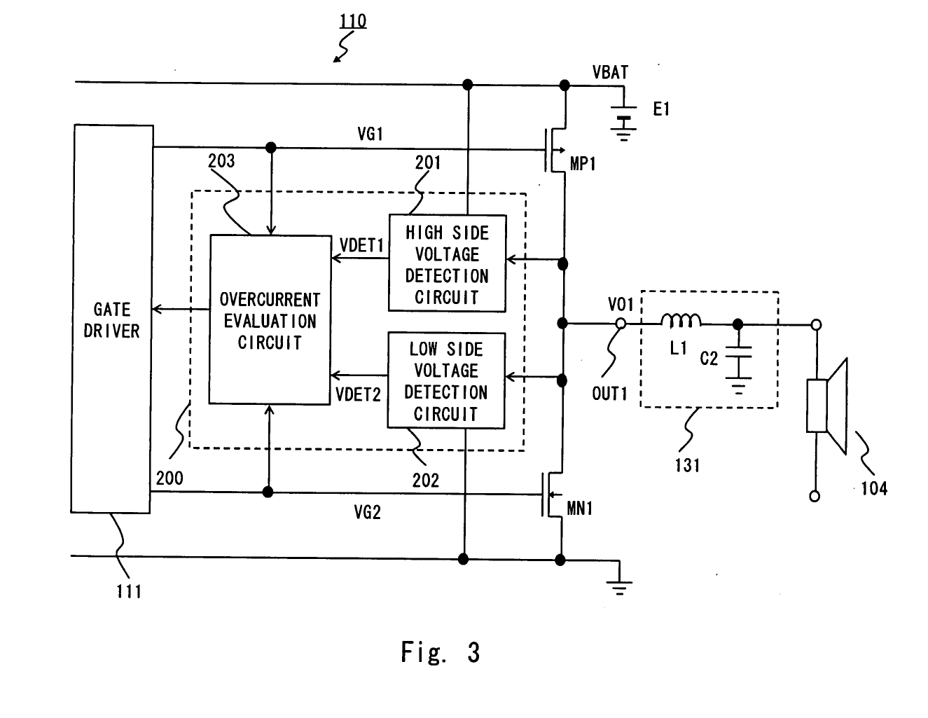

A configuration of the switching circuit of this embodiment is described hereinafter in detail with reference to FIG. 3. The switching circuit 110 shown in FIG. 1 is described hereinafter, however the switching circuit 120 has the same configuration as the switching circuit 110.

The switching circuit 110 includes an overcurrent detection circuit 200 in addition to the gate driver 111, the output transistor MP1 and MN1. The overcurrent detection circuit 200 detects an overcurrent flowing the output transistors MP1 and MN1. Specifically, the overcurrent detection circuit 200 detects an overcurrent condition of the output transistors MP1 and MN1. When the overcurrent detection circuit 200 detects an overcurrent of the output transistors MP1 and MN1, it notifies the detection of the overcurrent to the gate driver 111. Once the overcurrent was detected, the gate driver 111 stops generating the gate voltage and the gate driver 111 is turned off. Specifically, the gate driver 111 stops an operation of turning on and off corresponding to the input signal. This prevents the output transistors MP1 and MN1 to be destroyed when an overcurrent is generated.

The overcurrent detection circuit 200 includes a high side voltage detection circuit 201, a low side voltage detection circuit 202, and an overcurrent evaluation circuit 203.

The high side voltage detection circuit 201 detects drain-source voltage Vds of the output transistor MP1 of high side. The high side voltage detection circuit 201 compares the reference voltage that is equal with a voltage that may be generated while the output transistor MP1 was in an overcurrent condition with the voltage Vds detected in the output transistor MP1. Then a result of the comparison is output to the overcurrent evaluation circuit 203 as a detection signal VDET1. If the voltage Vds of the output transistor MP1 is higher than the reference voltage, the voltage Vds is output. If the voltage Vds is lower than the reference voltage, the voltage will not be output.

The low side voltage detection circuit 202 detects drain-source voltage Vds of the output transistor MN1 of low side. The low side voltage detection circuit 202 as with the high side voltage detection circuit 201 compares the reference voltage that is equal with a voltage that may be generated while the output transistor MP2 was in an overcurrent condition with the voltage Vds detected in the output transistor MP2. Then a result of the comparison is output to the overcurrent evaluation circuit 203 as a detection signal VDET2.

The overcurrent evaluation circuit 203 evaluates an overcurrent condition of the output transistor MN1 according to a gate voltage VG1 of the output transistor MP1 and the detection signal VDET1 of the high side voltage detection circuit 201. Further, the overcurrent evaluation circuit 203 evaluates an overcurrent condition of the output transistor MN1 according to a gate voltage VG2 of the output transistor MN1 and the detection signal VDET2 of the low side voltage detection circuit 202.

For example the overcurrent evaluation circuit 203 can be formed by a logic circuit etc. With the gate voltage VG1 being low level and the detection signal VDET1 being low level, the output transistor MP1 is evaluated to be overcurrent. With the gate voltage VG2 being high level and the detection signal VDET2 being low level, the output transistor MN1 is evaluated to be overcurrent. Then the overcurrent evaluation circuit 203 outputs a result of the overcurrent evaluation to the gate driver 111.

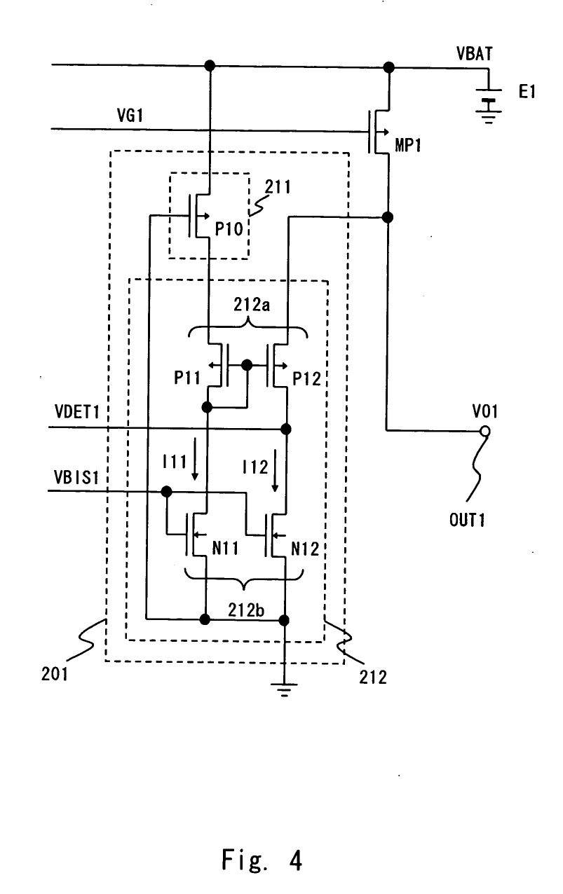

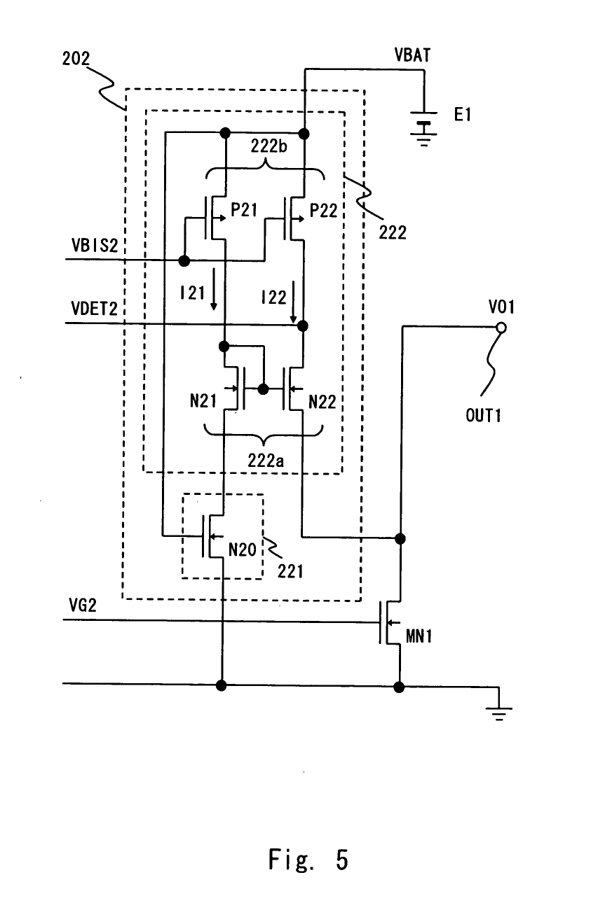

Configurations of the high side voltage detection circuit 201 and the low side voltage detection circuit 202 are described hereinafter in detail with reference to FIGS. 4 and 5. The configuration of the high side voltage detection circuit 201 corresponds to a P channel type output transistor. The configuration of the low side voltage detection circuit 202 corresponds to an N channel type output transistor.

As shown in FIG. 4, the high side voltage detection circuit 201 is provided between the power supply E1 (a high potential power supply) that supplies the power supply voltage VBA and the GND potential (a low potential power supply). The high side voltage detection circuit 201 includes a reference voltage generation unit 211 and a differential amplifier 212.

The reference voltage generation unit 211 generates the reference voltage. The reference voltage is almost the same as the voltage Vds that is generated while an overcurrent flows the output transistor MP1. The reference voltage generation unit 211 is a resistor having a resistance of a specified ratio against an on resistance of the output transistor MP1. In this example the reference voltage generation unit 211 is formed by MOS transistors of the same conductivity type (i.e. P channel type) as the output transistor MP1. A transistor P10 is a replication circuit of the output transistor MP1. The transistor P10 is a transistor having a specified size ratio against the output transistor MP1. A source (a first terminal) of the transistor P10 is connected to a source of the output transistor MP1. The power supply voltage VBAT is supplied to the source of the transistor P10 and the source of the output transistor MP1. The transistor P10 has a gate connected to ground and a drain (a second terminal) connected to the differential amplifier 212. As the gate of the transistor P10 is connected to ground, the transistor P10 is always turned on.

For example with the power supply voltage VBAT 3.6V and the reference voltage 0.2V, a drain voltage of the transistor P10 is 3.4V. Generally an on resistance of the output transistor MP1 is small, thus the reference voltage has a low value. A voltage close to the power supply voltage is input to the differential amplifier 212. Accordingly the differential amplifier 212 needs to be able to compare two voltages that are close to the power supply voltage. Thus the differential amplifier 212 is configured as a circuit that is source input and drain output and a gate in common type.

The differential amplifier 212 performs a differential amplification based on the input reference voltage of the reference voltage generation unit 211 and the input voltage Vds of the output transistor MP1, so as to output the detection signal VDET1. The differential amplifier 212 includes a detection signal generation circuit 212a and an active load circuit 212b. These circuits are formed by transistors P11, P12, N11, and N12.

The transistors P11 and P12 compare the voltage of the transistor P10 with a voltage of the output transistor MP1. The transistors P11 and P12 form the detection signal generation circuit 212a that generates the detection signal VDET1 according to the difference in the compared voltages. The detection signal generation circuit 212a detects the voltage of the output transistor MP1 while the output transistor MP1 is turned on, then generates the detection signal VDET1. In other words, the transistors P11, P12, and N12 is a comparator comparing the voltage generated in the transistor P10 by a current Ill flowing the transistor N11 with the output voltage of the output transistor MP1 to output the detection signal VDET1 that reflects a result of the comparison.

The transistors P11 and P12 are P channel type MOS transistors, connected in current mirror configuration. That is, gates of the transistors P11 and P12 are connected in common. Further, the gates are connected to a drain of the transistor P11. A source of the transistor P11 is connected to the drain of the transistor P10. An intermediate node between the source and the drain is an input terminal of the differential amplifier 212. The drain of the transistor P11 is connected to the active load circuit 212b. A source of the transistor P12 is connected to the drain of the output transistor MP1. An intermediate node between the source of the transistor P12 and the drain of the output transistor MP1 is another input terminal of the differential amplifier 212. The drain of the transistor P12 is connected to the active load circuit 212b, and an intermediate node between them is an output terminal for the detection signal VDET1.

For example with a source potential of the transistor P11 being 3.4V and a source potential of the transistor P12 being smaller than 3.4V, the drain of the transistor P12 outputs low level. Further, with the source potential of the transistor P12 being larger than 3.4V, the drain of the transistor P12 outputs high level.

The transistor N11 (a first constant current source) and-the transistor N12 (a second constant current source) form the active load circuit 212b. The active load circuit 212b is a current source that passes a constant current to the reference voltage generation unit 211 and the detection signal generation circuit 212a. The transistor N11 is connected to a current path of a side of the drain of the transistor P10. The transistor N11 passes the constant current I11 to the transistors P10 and P11 corresponding to a constant bias voltage VBIS1. The transistor N12 passes a constant current I12 to the transistor P12 corresponding to the constant bias voltage VBIS1. With the transistor P12 being turned on, a potential of an intermediate node between the transistor P12 and the transistor N12 is to be a high level. With the transistor P12 being turned off, a potential of the intermediate node between the transistor P12 and the transistor N12 is to be a low level.

The transistors N11 and N12 are N channel type MOS transistors. The transistor N11 is connected in series with the transistors P10 and P11. A drain of the transistor N11 is connected to the drain of the transistor P11, and a source of the transistor N11 is connected to ground. The bias voltage VBIS1 is supplied to a gate of the transistor N11. The transistor N12 is connected in series with the transistor P12. The transistor N12 has a drain connected to a drain of the transistor P12 and a source connected to ground. The bias voltage VBIS1 is supplied to a gate of the transistor N12.

In this embodiment, sizes of the transistors P10 and the output transistor MP1, a current I11, and an overcurrent (IMAX) that is to be detected by the output transistor MP1 are made to satisfy the following two conditions.

A first condition is that a channel length (L10) of the transistor P10 and a channel length (L20) of the output transistor MP1 need to be the same (i.e. L10=L20). A second condition is that a ratio of the current Ill against a channel width (W10) of the transistor P10 and a ratio of the overcurrent (IMAX) that is to be detected by the output transistor MP1 against a channel width (W20) of the output transistor MP1 need to be the same (i.e. W10/I11=W20/IMAX). For example, W10=10 μm, I11-100 μA, W20=50 mm, and IMAX=500 mA. Satisfying the conditions enables the transistor P10 to generate the same voltage as a voltage generated in an overcurrent condition, reduces the size of the transistor P10, and also reduces power consumption.

The transistor P10 and the output transistor MP1 should be manufactured in the same process and positioned adjacent with each other on a semiconductor chip. This suppresses variations in production tolerance of the transistor P10 and the output transistor MP1, and also variations in heat characteristic of the transistors. Accordingly a reference voltage can be generated more accurately, improving an accuracy of an overcurrent detection.

As shown in FIG. 5, the low side voltage detection circuit 202 is the high side voltage detection circuit 201 with conductivity types of each transistors being changed. Thus the low side voltage detection circuit 202 is described briefly.

The low side voltage detection circuit 202 includes a reference voltage generation unit 221 and a differential amplifier 222. The reference voltage generation unit 221 is formed by an N channel transistor N20 with its source terminal connected to ground. The power supply voltage VBAT is supplied to a gate of the transistor N20. Thus the transistor N20 is always turned on. A current I21 flows the transistor N20, and the transistor N20 generates the reference voltage almost same as the voltage Vds generated when an overcurrent flows in the output transistor MN1.

The differential amplifier 222 includes a detection signal generation circuit 222a and an active load circuit 222b. The detection signal generation circuit 222a is formed by N channel type transistors N21 and N22. The active load circuit 222b is formed by P channel type transistors P21 and P22. The transistors N21 and N22 compare a voltage of the transistor N20 and a voltage of the output transistor MN1, and output the detection signal VDET2 from a drain of the transistor N22. The transistor P21 passes the current I21 corresponding to a bias voltage VBIS2 to the transistors N20 and N21. The transistor P22 passes a current I22 corresponding to the bias voltage VBIS2 to the transistor N22.

In the low side voltage detection circuit 202, sizes of the transistor N20 and the output transistor MN1, the currents I21 and I22 are set under the same conditions as the high side voltage detection circuit 201.

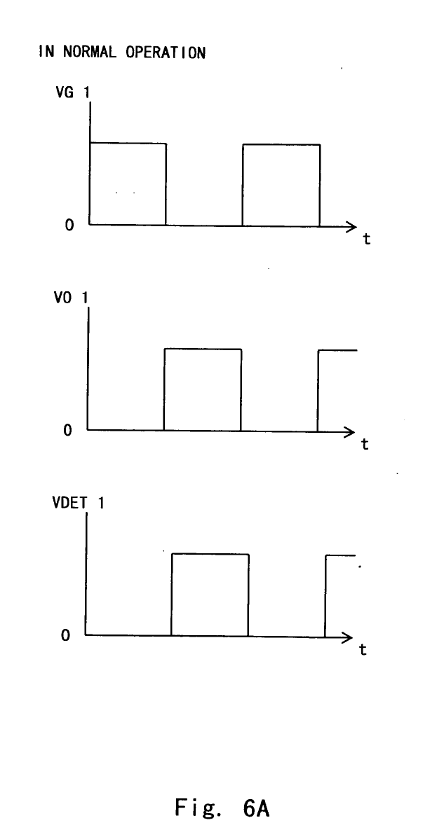

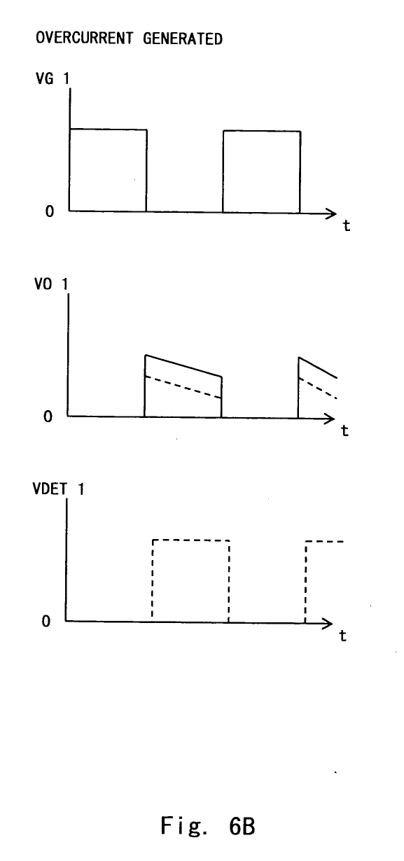

An operation of the high side voltage detection circuit 201 is described hereinafter in detail with reference to FIGS. 6A and 6B. An operation of the low side voltage detection circuit 202 is identical to the operation of the high side voltage detection circuit 201, thus the explanation will not be repeated here.

FIGS. 6A and 6B illustrate each signal with an input signal being 0 input. FIG. 6A illustrates signals in a normal operation. FIG. 6B illustrates waveforms of signals when an overcurrent is generated.

As shown in FIG. 6A, a pulsing gate voltage VG1 is supplied to the gate of the output transistor MP1 by the gate driver 111 in a normal operation. Then the output transistor MP1 is turned on and off according to the gate voltage VG1, and a pulsing output voltage VO1 is output. In this case as the output transistor MP1 is a P channel type. Thus when the gate voltage VG1 is high level, the output transistor MP1 is turned off and the output voltage VO1 becomes low level. Further, when the gate voltage VG1 is low level, the output transistor MP1 is turned on and the output voltage Vol becomes high level.

At this time the detection signal VDET1 is output according to a level of the output voltage VO1. Specifically when the output transistor MP1 is turned on and the output voltage VO1 is high level, the detection signal VDET1 also becomes high level.

When the output voltage VO1 becomes high level, a drain potential of the transistor P10 becomes the same potential as of a drain potential of the output transistor MP1. Then gate-source voltage Vgs of the transistor P12 increases and the transistor P12 is turned on. At this time the current I12 increases, thus the detection signal VDET1 becomes high level. The detection signal VDET1 rises with a delay until the transistor P12 operates according to the output voltage VO1.

When the output voltage VO1 becomes low level, the drain potential of the output transistor MP1 becomes lower than the drain potential of the transistor P10. Then gate-source voltage Vgs of the transistor P12 decreases and the transistor P12 is turned off. At this time the current I12 decreases, thus the detection signal VDET1 becomes low level. The detection signal VDET1 falls with a delay until the transistor P12 operates according to the output voltage VO1.

On the other hand as shown in FIG. 6B, assumed that a load is short-circuited while the pulsing gate voltage VG1 is being supplied to the gate of the output transistor MP1 by the gate driver 111. Then when the output transistor MP1 is turned on, a normal voltage is not generated in the output terminal OUT1. Accordingly the output voltage VO1 does not rise to a normal high level, and an overcurrent flows the output transistor MP1. At this time the output voltage VO1 fluctuates due to a condition of short-circuit and failure of the load, possibly decreases to a level indicated with dotted line of FIG. 6B or even to 0V.

When the output transistor MP1 turned on and the output voltage VO1 is lower than the normal high level, an operation is same as when the output voltage VO1 is low level. That is, the drain potential of the output transistor MP1 remains to be lower than the drain potential of the transistor P10. Accordingly, the gate-source voltage Vgs of the transistor P12 is low and the transistor P12 is turned off and the current I12 does not flow. Thus the detection signal VDET1 of a level of a dotted line in FIG. 6B will not be output, and the detection signal remains to be low level.

If the detection signal VDET1 is high level in a period while the output transistor MP1 is to be on-state, the overcurrent evaluation circuit 203 that receives the detection signal VDET1 evaluates the condition of the output transistor MP1 as a normal condition. Further, if the detection signal VDET1 is low level in a period while the output transistor MP1 is to be on-state, the overcurrent evaluation circuit 203 evaluates the condition of the output transistor MP1 as an overcurrent condition. The overcurrent evaluation circuit 203 may evaluate it as the overcurrent condition once it detects a low level of the gate voltage VG1 and a low level of the detection signal VDET1. However the overcurrent evaluation circuit 203 may evaluate it as the overcurrent condition after it detects the low levels for a specified number of times. Further, it may evaluate it as the overcurrent condition with a consideration of a delay of the detection signal VDET1.

As described in the foregoing, a circuit for detecting a voltage of the output transistor in the overcurrent detection circuit is formed by five transistors, thereby realizing a simple circuit configuration. Devices such as an operational amplifier, a resistance, or a diode are not used as in a conventional technique. Therefore it is easy to downsize and integrate into a circuit, accordingly enabling to reduce consumption current. By incorporating the detection circuit to each output transistor of high and low sides of a push-pull circuit and to each output transistor of a full-bridge type, it is possible to further facilitates an integration and downsize.

The Detection Circuit

Furthermore, by manufacturing the reference voltage for a voltage detecting and the output transistor in a same process adjacent to each other, it is possible to suppress a variation in production tolerance and temperature characteristic, thereby improving detection accuracy.

### Second Embodiment

An overcurrent detection circuit of a second embodiment of the present invention is described hereinafter in detail. The overcurrent detection circuit of this embodiment synchronizes a transistor that generates a reference voltage with an output transistor to operate.

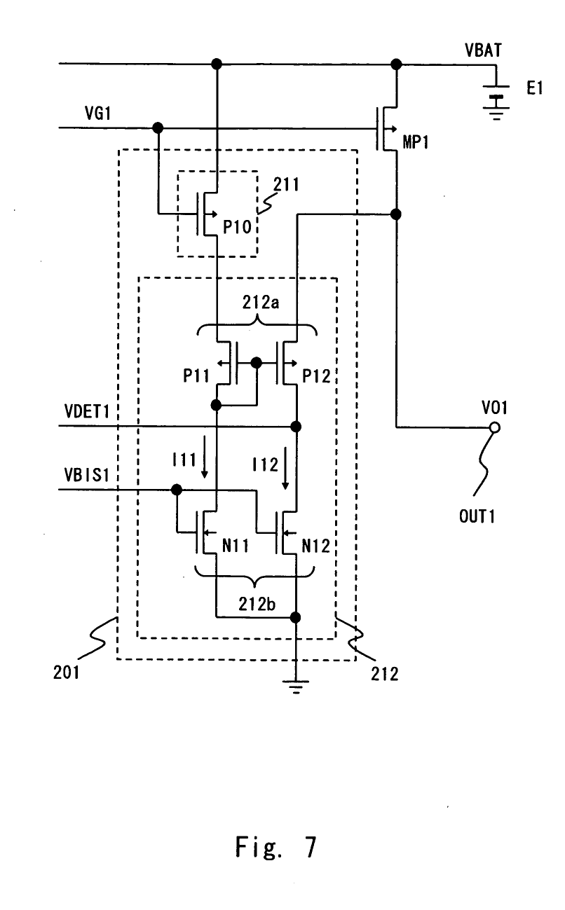

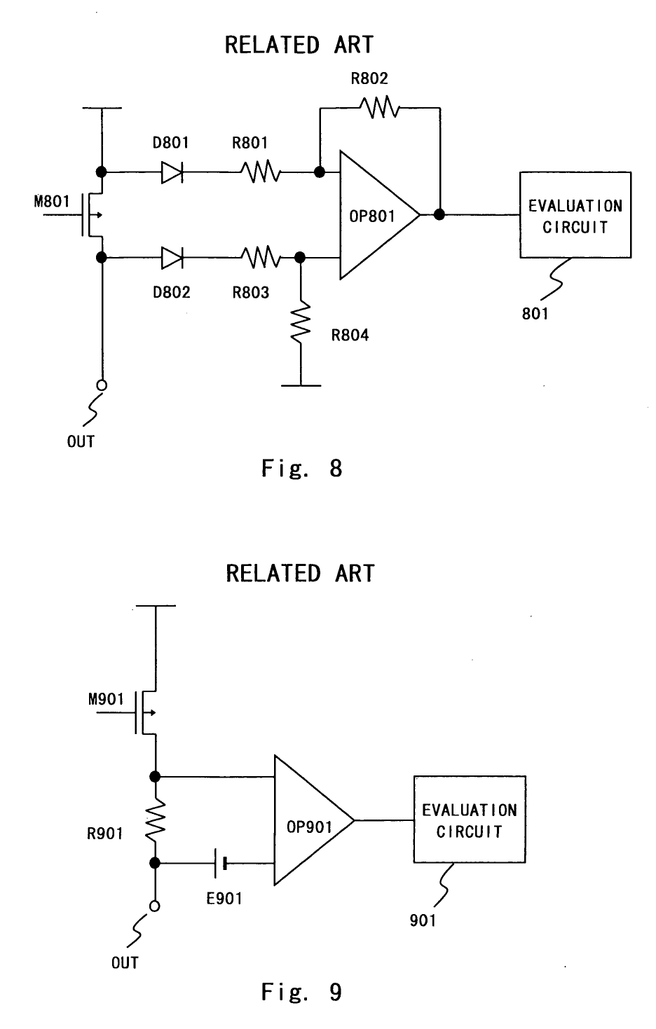

An entire configuration of the class D amplifier is identical to the first embodiment. A configuration of the high side voltage detection circuit 201 is described hereinafter in detail. FIG. 7 illustrates a configuration of the high side voltage detection circuit 201 of this embodiment. In FIG. 7, components identical to those in FIG. 4 are denoted by reference numerals identical to those therein.

Comparing to FIG. 4, the gate of the transistor P10 of the reference voltage generation unit 211 is connected to a different point. In this embodiment, the gate of the transistor P10 is connected in common with the gate of the output transistor MP1. Thus the transistor P10 repeats to turn on and off at the same timings with the output transistor MP1. Therefore only while the output transistor MP1 is turned on, the transistor P10 is turned on to generate the reference voltage. The voltage of the output transistor MP1 is detected according to the reference voltage.

Accordingly in this embodiment, the transistor P10 is turned off while the voltage of the output transistor MP1 needs not to be detected, that is a period while the output transistor MP1 is turned off. Thus a power consumption of the voltage detection circuit in this period can be reduced. For example with the duty ratio of the gate voltage VG1 of the output transistor MP1 being 50%, the power consumption of the voltage detection circuit can be reduced to half.

### Other Embodiment

In the above embodiment, an example incorporating the present invention to an output stage of the class D amplifier is described. However it is not limited to this but the present invention can be applied to the overcurrent detection circuit in other switching circuit.

It is apparent that the present invention is not limited to the above embodiment and it may be modified and changed without departing from the scope and spirit of the invention.

What is claimed is:

1. An overcurrent detection circuit detecting an overcurrent flowing a first switching device having a first terminal connected to a power supply and a second terminal connected to a load, the overcurrent detection circuit comprising:
a first resistor having a first terminal connected to the first terminal of the first switching device and a second terminal connected to a first constant current source; and
a first detection signal generation circuit generating a detection signal corresponding to a difference between a voltage of the second terminal of the first switching device and a voltage of the second terminal of the first resistor.

2. The overcurrent detection circuit according to claim 1, wherein the first resistor having a resistance of a specified ratio against an on resistance of the first switching device.

3. The overcurrent detection circuit according to claim 1, wherein the first detection signal generation circuit generates the detection signal while the first switching device being turned on.

4. The overcurrent detection circuit according to claim 1, wherein the first switching device is a first transistor,
the first resistor is a second transistor, and
the second transistor is formed with a specified size ratio against the first transistor.

5. The overcurrent detection circuit according to claim 4, wherein a channel length of the first transistor is substantially same as a channel length of the second transistor, and
a ratio of a current in an overcurrent condition of the first transistor against a channel width of the first transistor is substantially same as a ratio of a current of the first constant current source against a channel width of the second transistor.

6. The overcurrent detection circuit according to claim 5, wherein a gate terminal of the second transistor is connected to a high or a low potential power supply.

7. The overcurrent detection circuit according to claim 5, wherein a gate terminal of the second transistor is connected to a gate terminal of the first transistor.

8. The overcurrent detection circuit according to claim 1, wherein the first detection signal generation circuit comprises:
a third transistor having a first terminal connected to the second terminal of the first switching device and a second terminal connected to a second constant current source;
a fourth transistor having a first terminal connected to a second terminal of the first resistor and a second terminal connected to the first constant current source, and a gate terminal connected to a gate terminal of the third transistor and the first constant current source,
wherein the detection signal is output from a node between the third transistor and the second constant current source.

9. A switching circuit comprising:
a first switching device having a first terminal connected to a power supply and a second terminal connected to a load;
a first resistor having a first terminal connected to the first terminal of the switching device and a second terminal connected to a first constant current source;
a first detection signal generation circuit generating a detection signal corresponding to a difference between a voltage of the second terminal of the first switching device and a voltage of the second terminal of the first resistor; and
an evaluation circuit evaluating a condition of the first switching device according to a control signal supplied to the first switching device and the detection signal.

10. The switching circuit according to claim 9, wherein the evaluation circuit evaluates a condition of the first switching device according to a level of the detection signal in case the control signal controls the first switching device to be on.

11. The switching circuit according to claim 9, further comprises:
a second switching device having a first terminal connected to a power supply and a second terminal connected to a load;
a second resistor having a first terminal connected to the first terminal of the second switching device and a second terminal connected to a third constant current source; and
a second detection signal generation circuit generating a second detection signal corresponding to a difference between a voltage of the second terminal of the second switching device and a voltage of the second terminal of the second resistor,
wherein the evaluation circuit evaluates a condition of the second switching device according to a second control signal supplied to the second switching device and the second detection signal.

12. The switching circuit according to claim 11, wherein the evaluation circuit evaluates a condition of the second switching device according to a level of the second detection signal in case the second control signal controls the second switching device to be on.
